(19) United States
(12) Patent Application Publication
(10) Pub. No.: US 2024/0006600 A1
(43) Pub. Date: Jan. 4, 2024

(54) Anode Composite Interlayer for Lithium Metal Batteries

(71) Applicants: Nissan North America, Inc., Franklin, TN (US); Nissan Motor Co., Ltd., Yokohama-shi (JP)

(72) Inventors: Hideyuki Komatsu, San Diego, CA (US); Shigemasa Kuwata, Palo Alto, CA (US); Balachandran Gadaguntla Radhakrishnan, Mountain View, CA (US); Maarten Sierhuis, San Francisco, CA (US); Kazuyuki Sakamoto, Kanagawa (JP); Takuya Mishina, Kanagawa (JP)

(21) Appl. No.: 17/855,243

(22) Filed: Jun. 30, 2022

(51) Int. Cl. H01M 4/40; H01M 4/04; H01M 4/62; H01M 10/052

(52) U.S. Cl. CPC H01M 4/405; H01M 4/0404; H01M 4/625; H01M 10/052; H01M 2004/021

(57) ABSTRACT

A lithium metal battery cell has an electrolyte and an anode comprising an anode current collector and a composite interlayer formed on the anode current collector between the anode current collector and the electrolyte. The composite interlayer consists of conductive carbon and a metal additive, the composite interlayer configured to promote dense lithium deposition in the anode during charging. The metal additive in the composite interlayer is a metal that forms a solid solution with lithium metal.

### TECHNICAL FIELD

This disclosure relates to a composite interlayer provided between the electrolyte and the anode current collector of a lithium metal battery, the composite interlayer formed of conductive carbon and metal additive.

### BACKGROUND

Advances have been made toward high energy density batteries, including both lithium metal and lithium-ion batteries. However, these advances are limited by the underlying choice of materials and electrochemistry. Traditional lithium-ion batteries either use organic liquid electrolytes, prone to negative reactions with active materials, or ionic liquid electrolytes, with increased viscosities and lower ionic conductivity. All-solid-state batteries (ASSB) can address some or all of these issues, as well as produce higher energy densities. However, the large interfacial resistance at the electrolyte/electrode interface and the interfacial stability and compatibility due to lithium reactivity affect the electrochemical performance of both ASSBs and lithium metal batteries. Un-uniform lithium plating and formation of lithium dendrites contribute to the decrease in performance.

### SUMMARY

Disclosed herein are implementations of a lithium metal battery cell having an anode composite interlayer and lithium metal batteries comprising multiple battery cells.

As disclosed herein, a lithium metal battery cell can comprise an anode current collector, an electrolyte, and a composite interlayer between the anode current collector and the electrolyte. The composite interlayer is configured to promote uniform lithium metal plating and suppressing dendrite formation.

As also disclosed, a lithium metal battery cell can comprise a cathode comprising a lithium-containing cathode active material, an electrolyte, and an anode comprising an anode current collector and a composite interlayer formed on the anode current collector between the anode current collector and the electrolyte. The composite interlayer consists of conductive carbon and a metal additive, wherein the metal additive satisfies formula I:

η_{Li_depo_eff}=−432.76*E_{formation} (eV)+0.0724*R (nm)+2.7824 (I)

wherein η_{Li_depo_eff} is lithium deposition overvoltage and has a value of 0 mV to <15 mV; R is particle size of the metal additive; and E_{formation} is the formation energy at 1%/eV of Li99A, wherein A is the metal additive.

Also disclosed herein is a composite interlayer for use in a lithium metal battery cell, comprising conductive carbon and a metal additive, wherein the metal additive satisfies formula:

η_{Li_depo_eff}=−432.76*E_{formation}(eV)+0.0724*R (nm)+2.7824.

In the formula, η_{Li_depo_eff} is lithium deposition overvoltage and has a value of 0 mV to <15 mV; R is particle diameter of the metal additive; and E_{formation} is the formation energy at 1%/eV of Li99A, wherein A is the metal additive, and wherein the composite interlayer is configured to be formed directly on an anode current collector.

Variations in these and other aspects, features, elements, implementations, and embodiments of the methods and apparatus disclosed herein are described in further detail hereafter.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIG. 1 is a cross-sectional schematic of a lithium metal battery cell as assembled and prior to charging, as disclosed herein.

FIG. 2 is a cross-sectional schematic of a lithium metal battery cell after an initial charging, as disclosed herein.

FIG. 3 is a graph of formation energy of Li99A, A being a metal, against measured overpotential of lithium metal.

FIG. 4 is a graph of formation energy of Li99A against predicted overpotential using the developed formula as disclosed herein, showing the lithium deposition overpotential of stainless steel as an example.

FIG. 5 is a graph of formation energy versus measured overpotential for a variety of metals.

FIG. 6 is a graph showing the effect of different particle sizes on overpotential.

FIG. 7 is a graph of particle diameter versus predicted overpotential for various metal additives.

### DETAILED DESCRIPTION

Lithium metal batteries offer higher volumetric and gravimetric energy densities than conventional lithium-ion batteries. The lithium metal anode has a theoretical gravimetric capacity approximately ten times higher than graphite-based anodes. However, non-uniform electrodeposition of lithium, which results in dendrites, is holding back the widespread adoption of lithium metal batteries. During battery operation, lithium is continuously deposited or removed depending on charge/discharge cycles. As the lithium is deposited, it may not deposit uniformly, forming dendrites, which are tiny, rigid branch-like structures and needle-like projections. The formation of dendrites results in a non-uniform lithium surface which further exasperates non-uniform lithium deposition. As the dendrites grow from this non-uniform deposition, battery deterioration can occur. As the lithium dendrites reach the other electrode, short circuiting of the battery can occur.

Disclosed herein is a lithium metal battery cell having a composite interlayer between the anode current collector and the electrolyte. The composite interlayer is formed directly onto the anode current collector. The composite interlayer homogeneously and densely distributes deposited lithium between the composite interlayer and the anode current collector during charging. The dense lithium plating suppresses short circuiting and cell expansion during charging, improving volumetric energy density.

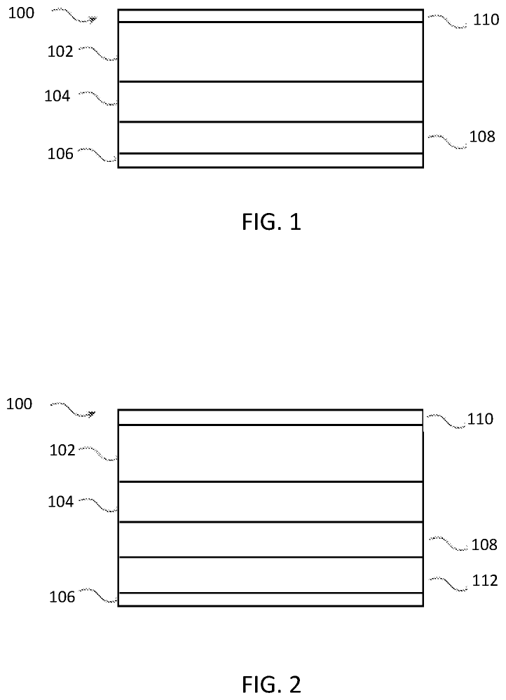

A lithium metal battery cell 100 as disclosed is illustrated schematically in cross-section in FIG. 1. The lithium metal battery cell 100 of FIG. 1 may be configured as a layered ASSB cell that includes as active layers a cathode 102 having active cathode material layer, an electrolyte 104 that is solid, and an anode current collector 106. A composite interlayer 108 as disclosed herein is formed on the anode current collector 106 between the anode current collector 106 and the electrolyte 104. In addition, the lithium metal battery cell 100 of FIG. 1 may include a cathode current collector 110, configured such that the active layers are interposed between the anode current collector 106 and the cathode current collector 110. Alternatively, the lithium metal battery cell 100 may use a liquid or gel electrolyte as electrolyte 104 and may further include a separator in the liquid or gel electrolyte between the composite interlayer 108 and the cathode 102. A lithium metal battery is formed of multiple lithium metal battery cells 100.

The anode current collector 106 can be, as a non-limiting example, a sheet or foil of stainless steel, copper, nickel, a copper-nickel alloy, carbon paper, or graphene paper.

In lithium metal batteries, the electrolyte 104 may include a liquid electrolyte, a polymer ionic liquid, a gel electrolyte, or a combination thereof. The electrolyte can be an ionic liquid-based electrolyte mixed with a lithium salt. The ionic liquid may be, for example, at least one selected from N-Propyl-N-methylpyrrolidinium bis(flurosulfonyl)imide, N-methyl-N-propylpyrrolidinium bis(trifluoromethanesulfonyl)imide, N-butyl-N-methylpyrrolidinium bis(trifluoromethylsulfonyl)imide, 1-butyl-3-methylimidazolium bis(trifluoromethylsulfonyl)imide, and 1-ethyl-3-methylimidazolium bis(trifluoromethylsulfonyl)imide. The salt can be or include, for example, a fluorosulfonyl (FS0) group, e.g., lithium bisfluorosulfonylimide (LiN(FS0₂)₂, (LiFSI), LiN(FS0₂)₂, LiN(FS0₂)(CF₃S0₂), LiN(FS0₂)(C₂F₅S0₂). In some embodiments, the electrolyte is or includes a cyclic carbonate (e.g., ethylene carbonate (EC) or propylene carbonate, a cyclic ether such as tetrahydrofuran (THF) or tetrahydropyran (TH), a glyme such as dimethoxyethane (DME) or diethoxyethane, an ether such as diethylether (DEE) or methylbutylether (MBE), their derivatives, and any combinations and mixtures thereof. Where a separator is used, such as with a liquid or gel electrolyte, the separator can be a polyolefine or a polyethylene, as non-limiting examples.

In ASSBs, the electrolyte 104 is solid. The solid electrolyte can be, as non-limiting examples, sulfide compounds (e.g. Argyrodite, LGPS, LPS, etc.), garnet structure oxides (e.g. LLZO with various dopants), NASICON-type phosphate glass ceramics (LAGP), oxynitrides (e.g. lithium phosphorus oxynitride or LIPON), and polymers (PEO).

The cathode current collector 110 can be, as a non-limiting example, an aluminum sheet or foil, carbon paper or graphene paper.

The cathode active material layer of the cathode 102 has cathode active material that can include one or more lithium transition metal oxides and lithium transition metal phosphates which can be bonded together using binders and optionally conductive fillers such as carbon black. Lithium transition metal oxides and lithium transition metal phosphates can include, but are not limited to, LiCoO₂, LiNiO₂,Li(Ni_{0.5}Mn_{0.5})O₂, LiMnO₂, Spinel Li₂Mn₂O₄, LiFePO₄, LiNiₓCo_{y}Mn_{z}O₂, LiNi_{0.8}Co_{0.15}Al_{0.05}O₂, and other polyanion compounds, and other olivine structures including LiMnPO₄, LiCoPO₄, LiNi_{0.5}Co_{0.5}PO₄, and LiMn_{0.33}Fe_{0.33}Co_{0.33}PO₄. The cathode active material layer 102 can be a sulfur-based active material and can include LiSO₂, LiSO₂Cl₂, LiSOCl₂, and LiFeS₂, as non-limiting examples.

FIG. 1 illustrates the assembled lithium metal battery cell 100 disclosed herein in a manufactured state, prior to charging. Depositing the interlayer 108 directly onto the anode current collector 106 allows for a thin, uniform, dense layer. If the interlayer 108 is deposited onto a pre-charge lithium metal anode, the lithium is too reactive and the interlayer will not be uniform. The method of deposition can be electronic beam vapor deposition, for example. FIG. 2 illustrates the lithium metal battery cell 100 after at least one charge, wherein lithium from the lithium-containing cathode material of the cathode 102 is deposited during charging between the composite interlayer 108 and the anode current collector 106, forming the lithium metal anode 112.

The composite interlayer 108 consists of conductive carbon and one or more metal additives that form a solid solution with lithium.

The cell is assembled in a discharged state with the initial charging step moving lithium metal through solid solution formation with the metal additive in the composite interlayer and to deposition of lithium metal between the anode current collector and the composite interlayer.

Starting with a discharged state of the lithium metal battery cell, the composite interlayer promotes the formation of a dense, uniform lithium metal anode through charging with the lithium metal being deposited with very low or no overpotentials. This has been demonstrated with both liquid electrolytes and solid electrolytes. The metal additives in the composite interlayer 108 are those metals that can form a solid solution in lithium. Such metals tend to have very low overpotentials while those metals that either form alloys with little solid solubility or those metals that do not form any intermetallic compounds, such as Cu and Ni, have very high overpotentials. The inventors have discovered that a composite interlayer consisting of conductive carbon with an overpotential with lithium of 15 mV combined with one or more metal additives having an overpotential with lithium of less than 15 mV, or 0 mV to <15 mV, results in dense, uniform deposition of the lithium metal during charging without the formation of dendrites.

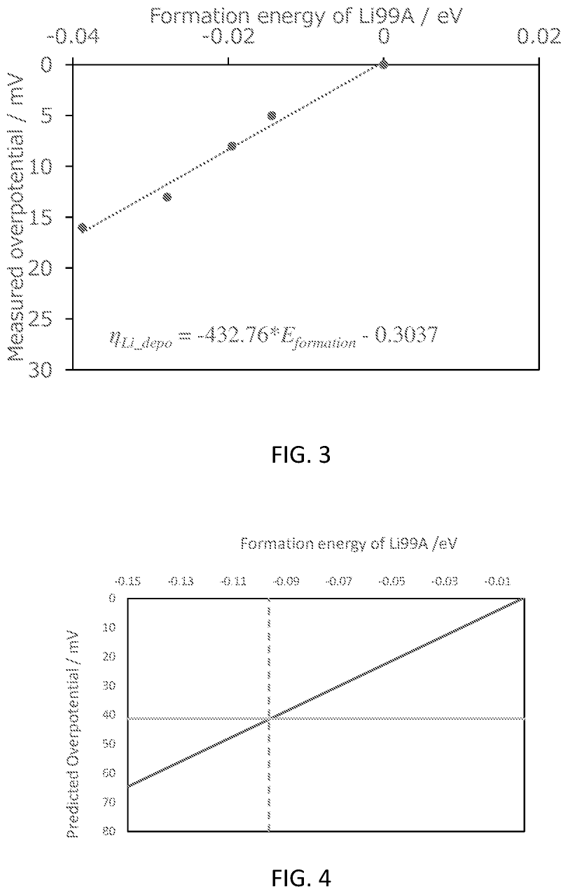

The inventors have also discovered that there is a linear correlation between the formation energy and the overpotential of lithium deposition. Overpotential (η_{Li_depo}) can be predicted by calculating the formation energy of Li99A, with A being a metal, using the following relationship, graphed in FIG. 3:

η_{Li_depo}=−432.76*E_{formation} (eV)−0.3037

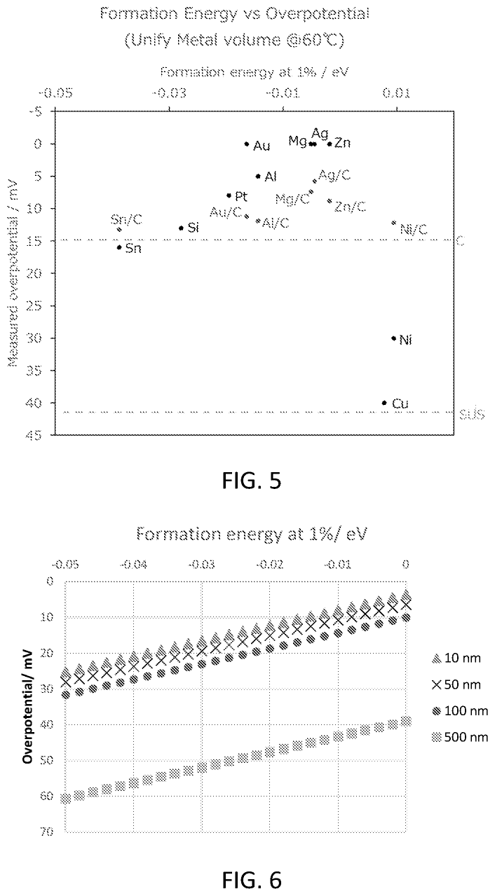

Stainless steel, the material often used as the anode current collector, has a formation energy of Li99A of −0.096 eV and so has a predicted overpotential of 41 mV using the formula above. See FIG. 4. The conventional lithium metal battery cells with no interlayer have significant problems with dendrite formation. The goal is to modify the anode current collector or the anode to significantly improve the uniformity and density of the lithium deposits. Performance will improve using materials having a lower predicted overpotential and a higher formation energy with lithium. FIG. 5 shows the overpotential for a variety of metals and carbon/metal composites. The overpotentials are low or close to zero if the solid solution formation energies are within +/−∈→0. As the formation energy increases to the right, the overpotential dramatically increases as is seen in the case of Ni and Cu. Both these metals do not form any solid solution or intermetallic compounds with lithium at room temperature. In the case of metals such as Al, Pt, and Sn, the formation enthalpy, while favorable, decreases, which also leads to an increase in overpotentials. The higher formation energy leads to stronger bonding between the metal atoms and lithium. On the other hand, the repulsive energy between, for example, Cu and lithium or Ni and lithium leads to larger overpotentials. A near zero formation energy ensures ease of mobility of the lithium ions, reflecting in near zero overpotentials.

The particle size of the metal additive has also been found to impact the predicted overpotential of the metal additive in the conductive carbon. A particle size effect has been determined and used as a correction for the predicted overpotential for the metal additives, allowing for the prediction of the lithium deposition overpotential of the composite interlayer. Particle size refers to the particle diameter. FIG. 5 shows the overpotential of particular metals alone as well as the change in the overpotential when the metal is used in combination with conductive carbon as in the composite interlayer. This change in overpotential is affected by the particle size of the metal. The particle size effect takes into account this change in overpotential based on particle size in combination with the conductive carbon.

FIG. 6 illustrates the impact particle size in combination with the formation energy has on the predicted overpotential. From this graph, the particle size correction was developed and is represented by the following formula:

[symbol]

η_{particle-effect}=0.0724*R_{particle} (nm)+3.0861

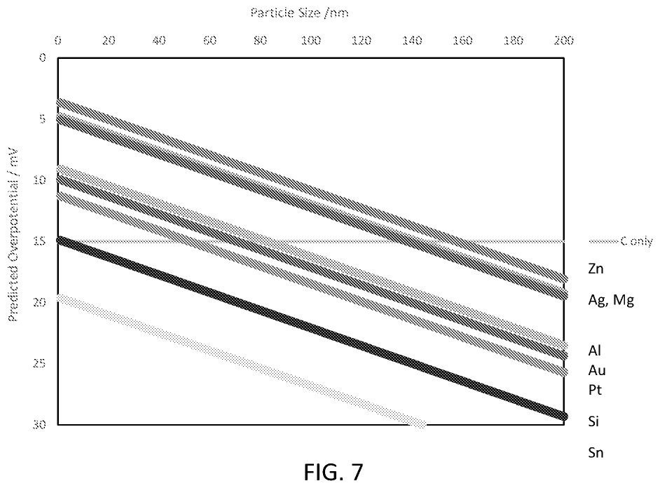

FIG. 7 graphs the particle size in nm against the predicted overpotential mV for different metal additives. The metal additives are listed in the legend in the order of the representative lines. To provide a composite interlayer that produces optimal lithium metal plating, the particle size of particular metal additives is: <157 nm for Zn; <141 nm for Ag; <138 nm for Mg; <82 nm for Al; <70 nm for Au; <52 nm for Pt; and <2 nm for Si. As shown in FIG. 7, Sn is another metal, along with Cu and Ni, that would not produce the desired lithium metal plating if used in the composite interlayer.

Combining the predicted overpotential formula with the particle size correction formula results in the following formula, used to determine the metal additives to be used in the composite interlayer:

η_{Li_depo_eff}=−432.76*E_{formation} (eV)+0.0724*R (nm)+2.7824.

In the formula, η_{Li_depo_eff} is lithium deposition overpotential and has a value of 0 mV to <15 mV; R is particle size of the metal additive; and E_{formation} is the formation energy at 1%/eV of Li99A, wherein A is the metal additive.

The composite interlayer disclosed herein consists of conductive carbon and one or more metal additives that satisfies the above equation, meaning the combination of formation energy and particle size produces an overpotential of 1 mV to <15 mV.

As used herein, the terminology “example”, “embodiment”, “implementation”, “aspect”, “feature”, or “element” indicates serving as an example, instance, or illustration. Unless expressly indicated, any example, embodiment, implementation, aspect, feature, or element is independent of each other example, embodiment, implementation, aspect, feature, or element and may be used in combination with any other example, embodiment, implementation, aspect, feature, or element.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. A lithium metal battery cell, comprising:
an electrolyte; and
an anode comprising:
an anode current collector; and
a composite interlayer formed on the anode current collector between the anode current collector and the electrolyte, the composite interlayer consisting of conductive carbon and a metal additive, the composite interlayer configured to promote dense lithium deposition in the anode during charging.

2. The lithium metal battery cell of claim 1, wherein the metal additive in the composite interlayer is a metal that forms a solid solution with lithium metal.

3. The lithium metal battery of claim 1, wherein the metal additive is one or more metals selected from Au, Al, Mg, Ag, Zn, Pt, and Si.

4. The lithium metal battery of claim 1, wherein the metal additive satisfies formula I:
η_{Li_depo_eff}=−432.76*E_{formation} (eV)+0.0724*R (nm)+2.7824 (I)
wherein η_{Li_depo_eff} is lithium deposition overpotential and has a value of 0 mV to <15 mV; R is particle diameter of the metal additive; and E_{formation} is formation energy at 1%/eV of Li99A, wherein A is the metal additive.

5. The lithium metal battery of claim 1, wherein the electrolyte is a solid electrolyte.

6. The lithium metal battery of claim 1, wherein the electrolyte is a liquid or gel electrolyte.

7. The lithium metal battery of claim 1, further comprising a cathode and a cathode current collector.

8. A lithium metal battery cell, comprising:
a cathode comprising a lithium-containing cathode active material;
an electrolyte; and
an anode comprising:
an anode current collector; and
a composite interlayer formed on the anode current collector between the anode current collector and the electrolyte, the composite interlayer consisting of conductive carbon and a metal additive, wherein the metal additive satisfies formula:
η_{Li_depo_eff}=−432.76*E_{formation}(eV)+0.0724*R (nm)+2.7824
wherein η_{Li_depo_eff} is lithium deposition overvoltage and has a value of 0 mV to <15 mV; R is particle diameter of the metal additive; and E_{formation} is formation energy at 1%/eV of Li99A, wherein A is the metal additive.

9. The lithium metal battery cell of claim 8, wherein the metal additive in the composite interlayer is a metal that forms a solid solution with lithium metal.

10. The lithium metal battery of claim 8, wherein the metal additive is one or more metals selected from Au, Al, Mg, Ag, Zn, Pt, and Si.

11. The lithium metal battery of claim 8, wherein the electrolyte is a solid electrolyte.

12. The lithium metal battery of claim 8, wherein the electrolyte is a liquid or gel electrolyte.

13. A composite interlayer for use in a lithium metal battery cell, comprising:
conductive carbon and a metal additive, wherein the metal additive satisfies formula I:
η_{Li_depo_eff}=−432.76*E_{formation} (eV)+0.0724*R (nm)+2.7824 (I)
wherein η_{Li_depo_eff} is lithium deposition overvoltage and has a value of 0 mV to <15 mV; R is particle diameter of the metal additive; and E_{formation} is the formation energy at 1%/eV of Li99A, wherein A is the metal additive, and
wherein the composite interlayer is configured to be formed directly on an anode current collector.
